(19) United States
(12) Patent Application Publication
(10) Pub. No.: US 2008/0152578 A1
(43) Pub. Date: Jun. 26, 2008

(54) APPARATUS FOR PRODUCING A STABLE OXY-CHLORO ACID

(76) Inventors: Amit Gupta, Aurora, IL (US); E.H. Kelle Zeiher, Naperville, IL (US); Martin R. Godfrey, Naperville, IL (US)

Correspondence Address: William J. Maheras;Patent and Licensing Department, Nalco Company, 1601 West Diehl Road, Naperville, IL, 60563-1198, US

(21) Appl. No.: 11/613,277

(22) Filed: Dec. 20, 2006

(51) Int. Cl. C01B 11/08; B01J 8/24

(52) U.S. Cl. 423/472; 422/145; 422/119

(57) ABSTRACT

The current invention relates to an apparatus for the production of stable oxy-chloro acid. The invention allows for simple ion exchange while modifying the pH to allow the chlorous acid to be in a stable form so that it does not rapidly degrading into chlorine dioxide and can be used as an effective biocide and cleaning composition. The apparatus also provides for an uninterrupted production of chlorous acid, which allows for the use of chlorous acid to be used in batch or continuous cleaning treatments.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the production of stable oxy-chloro (chlorous) acid for use as a biofouling control agent. The invention shows the method and the apparatus for production of chlorous acid in a stable form that allows for the production, storage and transportation of chlorous acid. The invention demonstrates the method of producing a stable and functional chlorous acid, which allows for the use of chlorous acid as biocidal composition or as a cleaning agent, without its rapid degradation into chlorine dioxide.

### BACKGROUND

The invention described here pertains to the automated production of a biofouling control agent. The basis for the production method is the use of ion exchange resins to convert a liquid solution from one chemical form to another less stable form.

Ion exchange is the reversible interchange of ions between a solid (ion exchange material) and a liquid in which there is no permanent change in the structure of the solid. Ion exchange is commonly used in water treatment and also provides a method of separation in many non-water processes. It has special utility in chemical synthesis, medical research, food processing, mining, agriculture and a variety of other areas.

Ion exchange has been in industrial use since circa 1910, with the introduction of water softening using natural and later, synthetic zeolites. Sulfonated coal, developed for industrial water treatment, was the first ion exchange material that was stable at low pH. Ion exchange reactions are reversible. By contacting a resin with an excess of electrolyte-the resin can be converted entirely to the desired salt form. The ion exchange process involves diffusion through the film of solution that is in close contact with the resins and diffusion within the resin particle. The process of ion exchange is best understood with the example of the most common application, water softening. Water softening accounts for the major tonnage of resin sales. Hard waters, which contain principally calcium and magnesium ions, cause scaling, such as in water pipes, domestic cooking utensils, and also cause soap precipitation which forms an undesirable gray curd and a waste of soap. Water softening involves the interchange of hardness for sodium on the resin. Typically, hard water is passed through a bed of a sodium cation exchange resin where the calcium ions from the water are exchanged for sodium ions from the resin, thus softening the water. Following the passage of hard water through the ion exchange resins, the resins are gradually depleted of their sodium content and require regeneration to maintain the effectiveness of the softening process. Regeneration of the exchanger involves the passage of a fairly concentrated solution of sodium chloride through the resin, where the sodium ion displaces the hardness ions from the resin beads.

The manufacture of ion exchange resins involves the preparation of a cross-linked bead copolymer either as cation resins, or as anion resins. As the name suggests, the type of resin used in an application depends on whether exchange of cations or anions is desired. For the purpose of this invention, the discussion will be restricted to technology that enables the exchange of cations mediated by the ion exchange resins. The cation exchange resins can be sub-divided into weak acid or strong acid cation resins. The weak acid resins have a high affinity for the hydrogen ion and are therefore easily regenerated with strong acids. The acid-regenerated resin exhibits a high capacity for the alkaline earth metals associated with alkalinity and a more limited capacity for the alkali metals with alkalinity. No significant salt splitting occurs with neutral salts. However, when the resin is not protonated (e.g., if it is depleted or has been neutralized with a caustic solution), softening can be performed, even in the presence of a high salt background. Strong acid resins are characterized by their ability to exchange cations or split neutral salts and are useful across the entire pH range.

Common examples of ion exchange resins applications include processes such as water softening, as described above; dealkalization, where the alkalinity is removed from the water in addition to the softening process; demineralization, where the net effect is the removal of electrolytes (minerals such as Na, Ca, Mg, etc) and a yield of purified water; and other processes such as wastewater treatment, catalysis and chemical processing, pharmaceuticals and fermentation, to name a few. Among the various applications described, the process of demineralization is closest to the method described in this invention.

Ion exchange demineralization is a two step process involving treatment with both cation and anion exchange resins. Water is passed first through a column of acid cation exchange resin that is in the hydrogen form to exchange the cation in solution, for example, Ca²⁺, Mg²⁺ and Na⁺, for hydrogen ions. The effluent is then passed over a column of anion exchange resin in the hydroxide form to replace anions in solutions, for example, C1⁻, SO₄²⁻ and NO₃⁻, with hydroxide anions. The hydrogen ions from the cation resin neutralize the hydroxide ions from the anion resin, resulting in the removal of minerals and production of purified water.

In the invention described here, a chlorite or chlorate salt solution of an alkali earth metal is passed through acidified cation exchange resins. Through this process, the cation from the salt solution is exchanged for the proton from the acidified resin, resulting in an acid form of the anion. As a result of salt passage, the acidified resins are gradually depleted of their acid (proton) content and require regeneration or re-acidification with an acid solution. Thus, this aspect of the described invention utilizes only the earlier half of the full demineralization process that has been well documented in the scientific literature.

Despite the long history of ion exchange use, it is perceived that references to automation, and monitoring for the specifics of production methods, and use of the product thereof is lacking.

### SUMMARY

The current invention describes the following key aspects:
1. It is an advantage of the invention to provide the production of oxy-chloro species in an automated manner.
2. It is an advantage of the invention to provide a method of production whereby a more stable form of the product is achieved.
3. It is an advantage of the invention to provide a process logic that allows for continuous or semi-continuous production of the oxy-chloro solution.
4. Provides a method for uninterrupted production.

### BRIEF DESCRIPTION OF THE FIGURES

FIG. 1 is a schematic view of the apparatus.

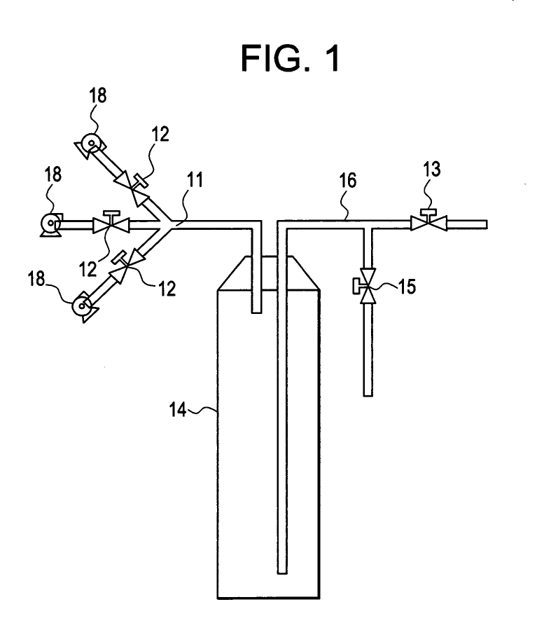

### DETAILED DESCRIPTION

The invention relates to an apparatus for automated production of chlorous acid is comprised of a branched intake valve 11 in conjunction with a resin bed 14 in fluid connection with a discharge line 16 including a drain valve 15 and a separate feed valve 13. The branched intake valve 11 has three supply valves 18 which feed chlorite salt, a solvent and an acid to the resin bed 14 where the preferred solvent is water. The apparatus further replenishes the resin bed with the acid from the intake valve 11 and the preferred acid is an inorganic acid that imparts a proton to the resin and the most preferred being HCL or H₂SO₄. The invention is an automated system allowing for the cleaning, preparation of the resin bed, production of chlorous acid and the rinsing of the system.

The invention further features the feed valve which transports the chlorous acid to the system to be treated which includes storage tanks to hold the chlorous acid until used in batch type applications or immediate transport to a system for instant cleaning. The invention further includes a sensor system within the resin bed to measure the efficacy of the resin bed and ascertain the time for regeneration of the resin bed to insure that stable chlorous acid is produced. The invention also includes a method of production of chlorous acid wherein the production begins with the rinsing of the system with water then, the acidification of the resin bed followed by a water rinse of resin bed then, a pre-feed salt flush of the system then the feeding of a salt of the chlorous acid into the resign bed to perform the ion exchange and produce stable chlorous acid and then a final rinse of the system with water. The preferred salt of the chlorous acid used in the method are chlorite and chlorate salts.

The foregoing may be better understood by reference to the following figures, which are intended to illustrate methods for carrying out the invention and are not intended to limit the scope of the invention.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

We claim:

1. An apparatus for automated production of oxy-chloro acid comprising:
(a) a branched intake valve in conjunction with;
(b) a resin bed in fluid connection with;
(c) a discharge line including a drain valve and a separate feed valve.

2. The apparatus of claim 1 where in the oxy-chloro acid is Chlorous acid.

3. The apparatus of claim 2 wherein the branched intake valve has three supply valves.

4. The apparatus of claim 3 wherein the supply valves feed chlorite salt, a solvent and an acid to the resin bed.

5. The apparatus of claim 4 wherein the solvent is water.

6. The apparatus of claim 4 wherein the acid is an inorganic acid that imparts a proton to the resin

7. The apparatus of claim 6 wherein the acid is HCL.

8. The apparatus of claim 6 wherein the acid is H₂SO₄.

9. The apparatus of claim 2 wherein the automated system allows for the cleaning, preparation of the resin bed, production of chlorous acid and the rinsing of the system.

10. The apparatus of claim 2 wherein the feed valve transports the chlorous acid to the system to be treated.

11. The apparatus of claim 2 wherein the feed valve transports the chlorous acid to a storage tank to be used in batch doses.

12. The apparatus of claim 2 where in there is a sensor system within the resin bed to measure the efficacy of the resin bed and determine the need for regeneration of the resin bed to ensure stable chlorous acid is produced.

13. A method for producing chlorous acid using the apparatus of claim 2 comprising:
(a) rinsing the system with water then;
(b) acidification of the resin bed followed by;
(c) water rinse of resin bed;
(d) pre-feed salt flush of the system then;
(e) the feeding of a salt of the chlorous acid into the resin bed to perform the ion exchange and produce stable chlorous acid;
(f) and then a final rinse of the system with water.

14. The acid used for the acidification of claim 13 is an inorganic acid.

15. The acid used for the acidification of claim 14 is hydrochloric acid.

16. The acid used for the acidification of claim 14 is sulfuric acid.

17. The salt of the chlorous acid of claim 13 is a chlorite salt.

18. The salt of the chlorous acid of claim 13 is a chlorate salt.

19. The apparatus of claim 2 wherein there is a sensor system at the exit point of the resin bed that measures the chlorous acid production.
